(19) United States
(12) Patent Application Publication
(10) Pub. No.: US 2026/0025472 A1
(43) Pub. Date: Jan. 22, 2026

(54) IMAGE READING APPARATUS AND PRINTING APPARATUS

(71) Applicant: SEIKO EPSON CORPORATION, TOKYO (JP)

(72) Inventors: Satoshi NAKATA, MATSUMOTO-SHI (JP); Katsumi YAMADA, Matsumoto-shi (JP); Kanji MOMOSE, MATSUMOTO-SHI (JP); Masanari TANAKA, SHIOJIRI-SHI (JP); Hirokazu ANADA, MATSUMOTO-SHI (JP)

(21) Appl. No.: 19/270,770

(22) Filed: Jul. 16, 2025

(30) Foreign Application Priority Data
Jul. 17, 2024 (JP) 2024-113885

(51) Int. Cl. H04N 1/00; H04N 1/034

(52) U.S. Cl. CPC H04N 1/00533; H04N 1/00607; H04N 1/00623; H04N 1/034

(57) ABSTRACT

An image reading apparatus includes a feed tray on which a medium is placed, a conveyance unit configured to convey, from the feed tray, the medium placed on the feed tray, an image reading unit configured to read an image from the medium conveyed by the conveyance unit, a discharge tray to which the medium from which the image was read by the image reading unit is discharged, and a housing. The feed tray and the discharge tray are capable of being pulled out in a pull-out direction, and, according to movement of one of the feed tray and the discharge tray in the pull-out direction, the other of the feed tray and the discharge tray moves in the pull-out direction.

The present application is based on, and claims priority from JP Application Serial Number 2024-113885, filed Jul. 17, 2024, the disclosure of which is hereby incorporated by reference herein in its entirety.

### BACKGROUND

### 1. Technical Field

The present disclosure relates to an image reading apparatus and a printing apparatus.

### 2. Related Art

There is known an image reading apparatus that is attached to a printing apparatus and reads an image from a target medium from which an image is read, the image reading apparatus including a feed tray on which the medium is placed, a conveyance unit that conveys, from the feed tray, the medium placed on the feed tray, an image reading unit that reads the image from the medium conveyed by the conveyance unit, a discharge tray on which the medium is discharged after the image has been read by the image reading unit, and a housing that houses the conveyance unit and the image reading unit on the inside. The feed tray and the discharge tray are capable of being pulled out in a pull-out direction (see JP-A-2023-167889).

JP-A-2023-167889 is an example of the related art.

In the image reading apparatus as described in JP-A-2023-167889, although both of a direction in which the feed tray is pulled out and a direction in which the discharge tray is pulled out are the same pull-out direction, a user has to individually pull out the feed tray and the discharge tray in the pull-out direction. This sometimes deteriorates the convenience of the user and is undesirable.

### SUMMARY

According to an aspect of the present disclosure, there is provided an image reading apparatus that is attached to a printing apparatus and reads an image from a target medium from which the image is read, the image reading apparatus including: a feed tray on which the medium is placed; a conveyance unit configured to convey, from the feed tray, the medium placed on the feed tray; an image reading unit configured to read an image from the medium conveyed by the conveyance unit; a discharge tray to which the medium from which the image was read by the image reading unit is discharged; and a housing configured to house the conveyance unit and the image reading unit on an inside, wherein the feed tray and the discharge tray are capable of being pulled out in a pull-out direction, and, according to movement of one of the feed tray and the discharge tray in the pull-out direction, the other of the feed tray and the discharge tray moves in the pull-out direction.

### BRIEF DESCRIPTION OF THE DRAWINGS

FIG. 1 is a perspective view illustrating an example of an exterior including a front surface of an image reading apparatus according to an embodiment.

FIG. 2 is a side cross-sectional view illustrating an example of a configuration of the image reading apparatus attached to a printing apparatus.

FIG. 3 is a side view illustrating an example of a configuration of a feed tray and a discharge tray.

FIG. 4 is a side cross-sectional view of the image reading apparatus illustrated in FIG. 3 cut such that an exterior of a positioning section can be seen.

FIG. 5 is a side cross-sectional view illustrating the feed tray in the case in which a first section to be engaged and a third engaging section are engaged.

FIG. 6 is a perspective view illustrating an example of the feed tray pulled out in a pull-out direction together with the discharge tray by pulling out the discharge tray in the pull-out direction.

FIG. 7 is a perspective view illustrating an example of a state in which the upstream end of the feed tray in a second state is lifted upward.

FIG. 8 is a side view illustrating another example of the configuration of the feed tray and the discharge tray.

FIG. 9 is a perspective view illustrating an example of a state in which a state of the feed tray is a first state in the image reading apparatus according to a modification 1 of the embodiment.

FIG. 10 is a diagram illustrating an example of the discharge tray pulled out in the pull-out direction together with the feed tray by pulling out the feed tray in the pull-out direction.

FIG. 11 is a perspective view illustrating another example of the state in which the upstream end of the feed tray in the second state is lifted upward.

FIG. 12 is a side view illustrating still another example of the configuration of the feed tray and the discharge tray.

FIG. 13 is a perspective view illustrating an example of a state in which a first gear and a second gear of a moving mechanism are housed in a housing.

### DESCRIPTION OF EMBODIMENTS

### Embodiment

An embodiment of the present disclosure is explained below with reference to the drawings.

### Overview of an Image Reading Apparatus According to the Embodiment.

First, an overview of an image reading apparatus according to the embodiment is explained.

The image reading apparatus according to the embodiment is attached to a printing apparatus and reads an image from a target medium from which the image is read. The image reading apparatus includes a feed tray, a conveyance unit, an image reading unit, a discharge tray, and a housing. The feed tray is a tray on which a medium is placed. The conveyance unit conveys, from the feed tray, the medium placed on the feed tray. The image reading unit reads an image from the medium conveyed by the conveyance unit. The discharge tray is a tray on which the medium is discharged after the image has been read by the image reading unit. The housing houses the conveyance unit and the image reading unit on the inside. Here, the feed tray and the discharge tray can be pulled out in a pull-out direction. In the image reading apparatus, according to movement of one of the feed tray and the discharge tray in the pull-out direction, the other of the feed tray and the discharge tray moves in the pull-out direction. Accordingly, the image reading apparatus can reduce labor and time of a user for individually pulling out the feed tray and the discharge tray. As a result, it is possible to improve the convenience of the user.

The configuration of the image reading apparatus according to the embodiment is explained in detail below.

### Configuration of the Image Reading Apparatus According to the Embodiment

A configuration of the image reading apparatus according to the embodiment is explained below with reference to an image reading apparatus 1 by way of example.

Note, in the embodiment, a user of the image reading apparatus 1 is simply referred to as user for convenience of explanation. In the present specification, a three-dimensional coordinate system TC is a three-dimensional orthogonal coordinate system indicating directions in a figure in which the three-dimensional coordinate system TC is drawn. In the following explanation, an X axis in the three-dimensional coordinate system TC is simply referred to as X axis for convenience of explanation. In the following explanation, a Y axis in the three-dimensional coordinate system TC is simply referred to as Y axis for convenience of explanation. In the following explanation, a Z axis in the three-dimensional coordinate system TC is simply referred to as Z axis for convenience of explanation. In the following explanation, as an example, a case in which a negative direction of the Z axis coincides with the direction of gravity is explained. Therefore, in the following explanation, a positive direction of the Z axis is referred to as upward direction or simply referred to as upward and a negative direction of the Z axis is referred to as downward direction or simply referred to as downward for convenience of explanation. In the following explanation, for convenience of explanation, a positive direction of the X axis is referred to as forward direction or simply referred to as forward and a negative direction of the X axis is referred to as rearward direction or simply referred to as rearward.

In the following explanation, for convenience of explanation, a surface on the positive direction side of the X axis among surfaces of a certain object is referred to as front surface of the object and a surface on the negative direction side of the X axis among surfaces of the object is referred to as rear surface of the object. In the following explanation, an object being viewed in a certain direction is referred to as the object being viewed from the direction.

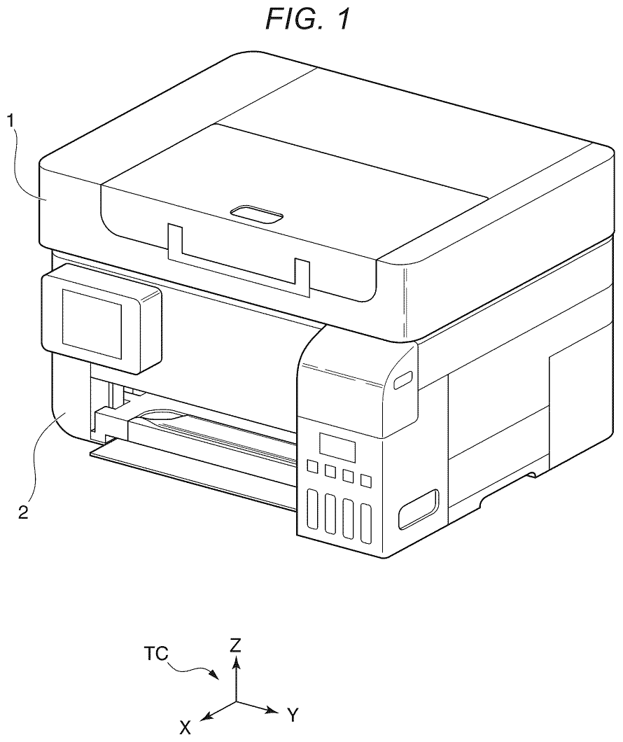

FIG. 1 is a perspective view illustrating an example of an exterior including a front surface of the image reading apparatus 1 according to the embodiment.

As illustrated in FIG. 1, the image reading apparatus 1 is attached to a printing apparatus 2 and reads an image from a target medium CP1 from which an image is read. The image reading apparatus 1 may be provided in the printing apparatus 2 or may not be provided in the printing apparatus 2. The printing apparatus 2 is, for example, an inkjet printer but may be a printer of another type instead. In the example illustrated in FIG. 1, when the printing apparatus 2 is viewed in the vertical direction, the printing apparatus 2 conveys a print medium in parallel to the X axis and prints an image on the conveyed print medium. The medium CP1 is, for example, a printed medium on which an image is printed but not always limited to the printed medium. In the following explanation, as an example, a case in which the medium CP1 is A4-size print paper on which an image is printed is explained.

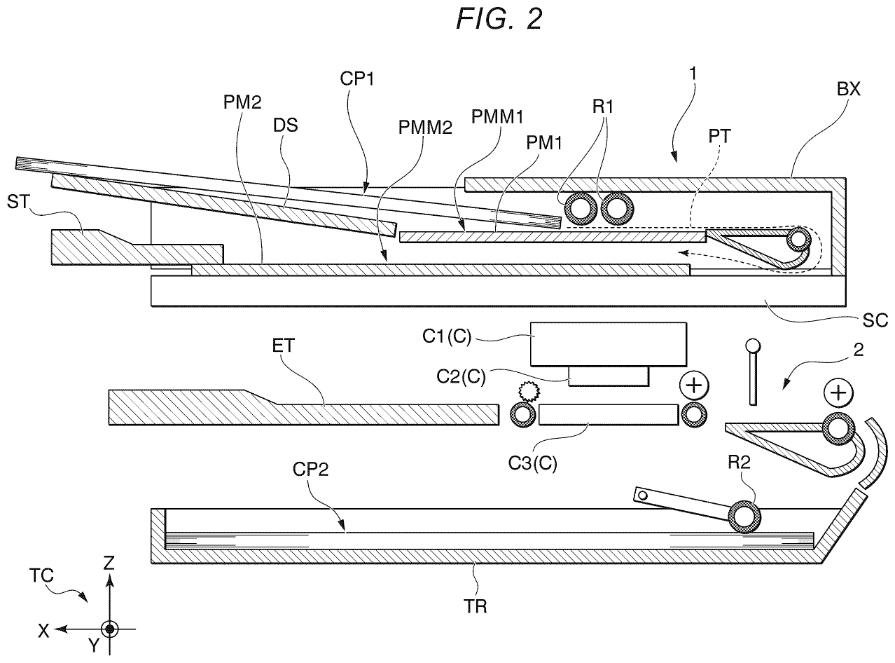

FIG. 2 is a side cross-sectional view illustrating an example of a configuration of the image reading apparatus 1 attached to the printing apparatus 2. In FIG. 2, a side cross-sectional view illustrating an example of a configuration of the printing apparatus 2 is illustrated together with the side cross-sectional view of the image reading apparatus 1.

As illustrated in FIG. 2, the image reading apparatus 1 includes a housing BX, a feed-side placement unit PM1, a conveyance unit R1, a feed tray DS, an image reading unit SC, a discharge-side placement section PM2, and a discharge tray ST. The image reading apparatus 1 may include other members in addition to the housing BX, the feed-side placement unit PM1, the conveyance unit R1, the feed tray DS, the image reading unit SC, the discharge-side placement section PM2, and the discharge tray ST.

The housing BX has a substantially rectangular parallelepiped shape as a whole and houses the members provided in the image reading apparatus 1. For this reason, the housing BX houses each of the feed-side placement unit PM1, the conveyance unit R1, the feed tray DS, the image reading unit SC, the discharge-side placement section PM2, and the discharge tray ST. Note that the housing BX may have another shape. The housing BX may be configured not to house some or all of the feed-side placement unit PM1, the feed tray DS, the discharge-side placement section PM2, and the discharge tray ST.

The feed-side placement unit PM1 is a member having a feed-side placement surface PMM1 on which one or more media CP1 are placed.

The conveyance unit R1 is a member that conveys the medium CP1 in a predetermined conveyance direction. In the example illustrated in FIG. 1, the conveyance unit R1 includes a pickup roller on the upstream side and includes a separation roller on the downstream side in the conveyance direction. The media CP1 placed on the feed-side placement surface PMM1 of the feed-side placement unit PM1 are conveyed one by one in the conveyance direction. Instead of the pickup roller and the separation roller, the conveyance unit R1 may include other members capable of conveying the media CP1 placed on the feed-side placement surface PMM1 of the feed-side placement unit PM1 one by one in the conveyance direction. In the following explanation, for convenience of explanation, the downstream end of a certain object in the conveyance direction is referred to as downstream end of the object and the upstream end of the object in the conveyance direction is referred to as upstream end of the object. The downstream end of the object refers to an end portion on the downstream side in the conveyance direction among end portions of the object. The upstream end of the object refers to an end portion on the upstream side in the conveyance direction among the end portions of the object.

Here, the conveyance direction is parallel to a direction in which the printing apparatus 2 conveys a printing medium when the image reading apparatus 1 is viewed from a direction orthogonal to the feed-side placement surface PMM1. In the example illustrated in FIG. 2, the conveyance direction is, for example, the vertical direction. Accordingly, in this case, the direction in which the printing apparatus 2 conveys the printed medium is the direction parallel to the X axis as described above. Therefore, in this case, the conveyance direction is also the direction parallel to the X axis. A dotted line PT illustrated in FIG. 2 indicates a part of a path on which the medium CP1 conveyed by the conveyance unit R1 passes. The conveyance direction may be a direction along the X axis. Furthermore, the conveyance direction may be expressed as direction along the negative direction of the X axis. In this case, the conveyance direction is a direction in which the medium CP1 is conveyed along the negative direction of the X axis in the path on which the medium CP1 conveyed by the conveyance unit R1 passes. In this case, a direction in which the medium CP1 is conveyed in the positive direction of the X axis after passing through a portion where the medium CP1 is curved and change a direction in the path may be expressed as direction opposite to the conveyance direction.

The feed tray DS is a member that supports the medium CP1 in conjunction with the feed-side placement unit PM1. The feed tray DS is located above the discharge tray ST. The feed tray DS is a tray that can be pulled out in a predetermined pull-out direction. By pulling out the feed tray DS in the pull-out direction, it is possible to expand a surface that supports the medium CP1 in conjunction with the feed-side placement surface PMM1 of the feed-side placement unit PM1. For this reason, the pull-out direction is a direction parallel to the conveyance direction. Here, in the examples illustrated in FIGS. 1 and 2, the medium CP1 is conveyed from the feed-side placement unit PM1 to the negative direction side of the X axis. In this case, the pull-out direction coincides with the positive direction of the X axis. That is, the pull-out direction is a direction opposite to the direction in which the medium CP1 is conveyed from the feed-side placement unit PM1. The direction in which the feed tray DS is pulled out may be expressed as first pull-out direction. The first pull-out direction may be a direction along the X axis.

More specifically, the feed tray DS can be displaced from a first state to a second state by being pulled out in the pull-out direction. In other words, the feed tray DS can be displaced from the first state to the second state by being pulled out in the first pull-out direction. Here, the first state is, among states of the feed tray DS, a state in which the feed tray DS is located at a first position determined in advance as a position where the feed tray DS is housed in the housing BX above the feed-side placement surface PMM1. On the other hand, the second state is, among the states of the feed tray DS, a state in which the feed tray DS is located at a second position determined in advance as a position where the feed tray DS supports the medium CP1 in conjunction with the feed-side placement unit PM1. The state of the feed tray DS illustrated in FIG. 2 is the second state. That is, the position where the feed tray DS is located illustrated in FIG. 2 is an example of the second position. For this reason, in the example illustrated in FIG. 2, the feed tray DS is coupled to the feed-side placement surface PMM1 of the feed-side placement unit PM1 and supports the medium CP1 in conjunction with the feed-side placement unit PM1. The feed tray DS may be referred to as document support. A joint between the upper surface of the feed tray DS and the feed-side placement surface PMM1 may have a step or may not have a step. When the joint between the upper surface of the feed tray DS and the feed-side placement surface PMM1 has a step, the downstream end of the upper surface of the feed tray DS is located above the upstream end of the feed-side placement surface PMM1.

The image reading unit SC reads an image from the medium CP1 conveyed by the conveyance unit R1. That is, the image reading unit SC is a scanner. More specifically, the image reading unit SC has a glass surface and reads an image from the medium CP1 passing over the glass surface. When the image reading unit SC is used as a flatbed scanner, a member located on the glass surface among members provided in the image reading unit SC is opened to expose the glass surface and the medium CP1 is set on the exposed glass surface. Accordingly, the image reading unit SC can read an image from the medium CP1 set on the glass surface.

The discharge-side placement section PM2 is a tray to which the medium CP1 from which the image has been read by the image reading unit SC is discharged. More specifically, the discharge-side placement section PM2: is a member having a discharge-side placement surface PMM2 on which one or more media CP1 are placed.

The discharge tray ST is a member that supports the medium CP1 in conjunction with the discharge-side placement section PM2. The discharge tray ST is a tray that can be pulled out in the pull-out direction explained above. By pulling out the discharge tray ST in the pull-out direction explained above, it is possible to expand a surface that supports the medium CP1 in conjunction with the discharge-side placement surface PMM2 of the discharge-side placement section PM2. The direction in which the discharge tray ST is pulled out may be expressed as second pull-out direction and, in this case, may be a direction different from the first pull-out direction explained above, which is the direction in which the feed tray DS is pulled out. In this case, the second pull-out direction may be a direction along the X axis.

More specifically, the discharge tray ST can be displaced from a third state to a fourth state by being pulled out in the pull-out direction. In other words, the discharge tray ST can be displaced from the third state to the fourth state by being pulled out in the second pull-out direction. Here, the third state is, among states of the discharge tray ST, a state in which the discharge tray ST is located at a third position determined in advance as a position where the discharge tray ST is housed in the housing BX above the discharge-side placement surface PMM2. On the other hand, the fourth state is, among the states of the discharge tray ST, a state in which the discharge tray ST is located at a fourth position determined in advance as a position where the discharge tray ST supports the medium CP1 in conjunction with the discharge-side placement surface PMM2. The state of the discharge tray ST illustrated in FIG. 2 is the fourth state. That is, the position where the discharge tray ST is located illustrated in FIG. 2 is an example of the fourth position. For this reason, in the example illustrated in FIG. 2, the discharge tray ST is coupled to the discharge-side placement surface PMM2 of the discharge-side placement section PM2 and supports the medium CP1 in conjunction with the discharge-side placement section PM2. The discharge tray ST may be referred to as stacker. A positional relationship between the feed tray DS and the discharge tray ST is not limited to the example illustrated in FIG. 2. The discharge tray ST may be present above the feed tray DS.

On the other hand, the printing apparatus 2 includes a paper feed tray TR, a conveyance unit R2, a printing unit C, a discharge tray ET, an operation unit (an operation panel), and an ink tank.

The paper feed tray TR is a tray on which a medium CP2 is placed as a print medium. The medium CP2 is, for example, A4-size print paper but, instead of this, may be another medium on which an image can be printed, such as a sticker mount. The discharge tray ET can be pulled out in a pull-out direction, which is a direction from the rear surface to the front surface of the housing BX. That is, the discharge tray ST and the feed tray DS provided in the image reading apparatus 1 can be pulled out in the same direction.

The conveyance unit R2 conveys the medium CP2 placed on the paper feed tray TR to the printing unit C. At this time, when the printing apparatus 2 is viewed in the vertical direction, the conveyance unit R2 conveys the medium CP2 to the printing unit C in parallel to the X axis.

The printing unit C prints an image on the medium CP2 conveyed by the conveyance unit R2. The printing unit C includes, for example, a carriage C1, a print head C2, and a platen C3.

The carriage C1 is mounted with the print head C2 and reciprocates the print head C2 along a predetermined scanning direction. The scanning direction is a direction intersecting the conveyance direction when the image reading apparatus 1 is viewed from the direction orthogonal to the feed-side placement surface PMM1. In the example illustrated in FIG. 2, the scanning direction is a direction orthogonal to the conveyance direction in the case, that is, a direction parallel to the Y axis.

The print head C2 prints an image on the medium CP2 passing between the print head C2 and the platen C3. In this example, the print head C2 is, for example, an inkjet print head but is not limited thereto.

The platen C3 supports the medium CP2 conveyed by the conveyance unit R2 below a path on which the print head C2 moves.

The discharge tray ET is a tray to which the medium CP2 on which the image has been printed by the printing unit C is discharged. The discharge tray ET can be pulled out in a pull-out direction, which is a direction from the rear surface to the front surface of the housing BX. That is, the discharge tray ST and the feed tray DS provided in the image reading apparatus 1 and the discharge tray ET and the paper feed tray TR on the printing apparatus 2 side can be pulled out in the same direction.

In the image reading apparatus 1 attached to the printing apparatus 2 having the configuration explained above, in response to the movement of one of the feed tray DS and the discharge tray ST in the pull-out direction, the other of the feed tray DS and the discharge tray ST moves in the pull-out direction. Accordingly, the image reading apparatus 1 can reduce labor and time for the user to individually pull out the feed tray DS and the discharge tray ST and, as a result, can improve the convenience of the user. Hereinafter, a configuration around the feed tray DS and the discharge tray ST is explained. Hereinafter, for convenience of explanation, the one tray is referred to as operation tray and the other tray is referred to as driven tray. In this case, for example, when the operation tray is the feed tray DS the driven tray is the discharge tray ST. On the other hand, in this case, for example, when the operation tray is the discharge tray ST, the driven tray is the feed tray DS.

### Configuration Around the Feed Tray and the Discharge Tray

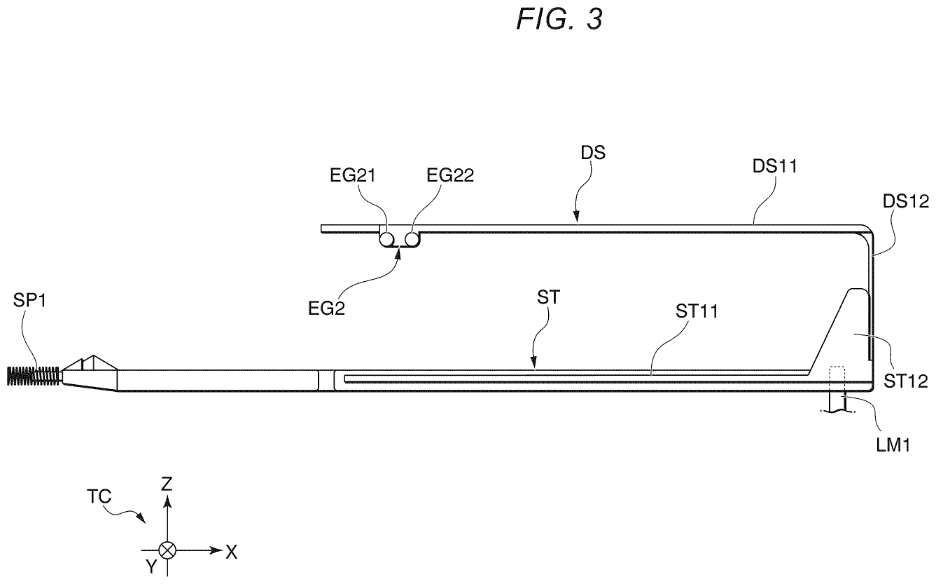

Hereinafter, a configuration around the feed tray DS and the discharge tray ST is explained. FIG. 3 is a side view illustrating an example of a configuration of the feed tray DS and the discharge tray ST. FIG. 3 illustrates each of the feed tray DS and the discharge tray ST when viewed in the positive direction of the Y axis. In the example illustrated in FIG. 3, the operation tray is the discharge tray ST. Further, in this example, the driven tray is the feed tray DS. Hereinafter, for convenience of explanation, a case in which a state of the feed tray DS is the first state and a state of the discharge tray ST is the third state is referred to as a case in which the state of the feed tray DS is the first state.

When viewed from the direction orthogonal to the feed-side placement surface PMM1, the feed tray DS can be displaced between the first state and the second state by being slid with respect to the feed-side placement unit PM1 in parallel to the conveyance direction. For this reason, as explained above, the feed tray DS can be displaced from the first state to the second state by being pulled out in the pull-out direction. Accordingly, even when there is no empty space above the image reading apparatus 1, the user can displace the state of the feed tray DS between the first state and the second state. That is, the feed tray DS is provided in the housing BX slidably between the first position and the second position. In order to implement the above, the feed tray DS includes, for example, a section to be positioned EG2 that is positioned by a positioning section EG1 provided in the housing BX. The feed tray DS may include a single section to be positioned EG2 or may include two or more sections to be positioned EG2. However, the number of positioning sections EG1 for positioning the sections to be positioned EG2 coincides with the number of sections to be positioned EG2.

In the example illustrated in FIG. 3, the feed tray DS includes two sections to be positioned EG2. That is, in the example, the sections to be positioned EG2 are respectively provided at both the end portions in the direction parallel to the Y axis among end portions of the feed tray DS. The two sections to be positioned EG2 face each other in the direction parallel to the Y axis and have the same configuration. For this reason, hereinafter, the configuration of the section to be positioned EG2 on the negative direction side of the Y axis of these two sections to be positioned EG2 is explained as an example of the configuration of the two sections to be positioned EG2.

The section to be positioned EG2 includes a first section to be engaged EG21 and a second section to be engaged EG22 that are disposed side by side in parallel to the pull-out direction when the feed tray DS is in the first state. In the example illustrated in FIG. 3, the first section to be engaged EG21 is located further downstream in the pull-out direction than the second section to be engaged EG22 when viewed in the direction orthogonal to the feed-side placement surface PMM1. The first section to be engaged EG21 and the second section to be engaged EG22 are cylindrical protrusions protruding from the feed tray DS in a direction orthogonal to the pull-out direction. In other words, the first section to be engaged EG21 and the second section to be engaged EG22 are cylindrical protrusions protruding from the feed tray DS in the negative direction of the Y axis. In this example, the first section to be engaged EG21 is separated from the second section to be engaged EG22. However, the first section to be engaged EG21 may be coupled to the second section to be engaged EG22. In FIG. 3, the section to be positioned EG2 on the positive direction side of the Y axis among the sections to be positioned EG2 provided in the feed tray DS is hidden behind the main body of the feed tray DS and is not seen.

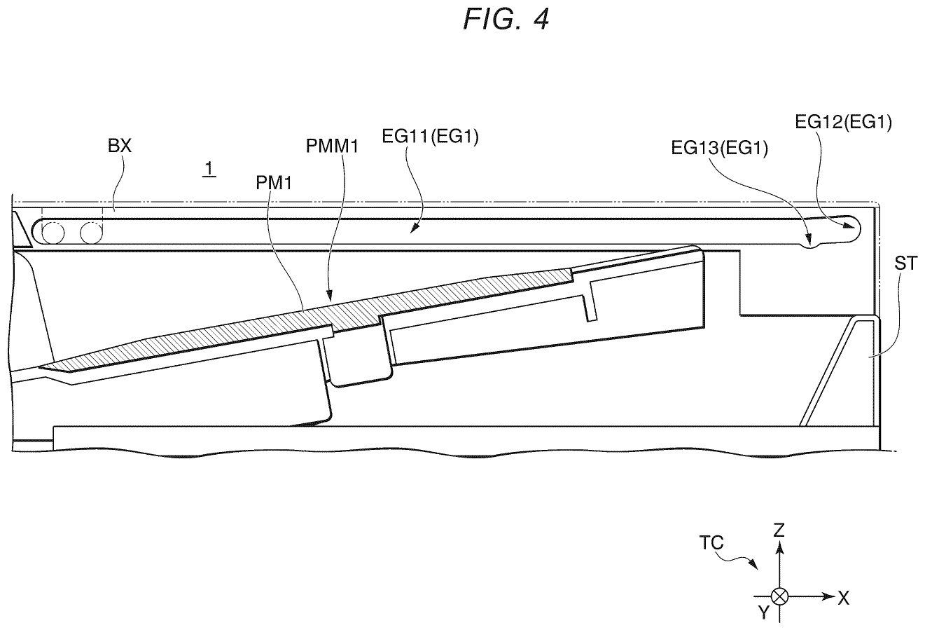

Here, FIG. 4 is a side cross-sectional view of the image reading apparatus 1 illustrated in FIG. 3 cut such that the exterior of the positioning section EG1 can be seen. However, in FIG. 4, in order to clearly show the configuration of the positioning section EG1, the feed tray DS is omitted. In an example illustrated in FIG. 4, the positioning section EG1 is provided at each of two inner walls intersecting the Y axis among inner walls of the housing BX. That is, in this example, the housing BX includes two positioning sections EG1. This is because, as explained above, the feed tray DS includes the two sections to be positioned EG2. The two positioning sections EG1 face each other in the direction parallel to the Y axis and have the same configuration. For this reason, hereinafter, a configuration of the positioning section EG1 on the positive direction side of the Y axis of the two positioning sections EG1 is explained as an example of the configuration of the two positioning sections EG1.

When the section to be positioned EG2 includes the first section to be engaged EG21 and the second section to be engaged EG22, the positioning section EG1 includes, for example, a first engaging section EG11 and a second engaging section EG12. In the example illustrated in FIG. 4, the first engaging section EG11 is located above the feed-side placement surface PMM1 and extends in a direction parallel to the pull-out direction. In the example, the downstream end of the first engaging section EG11 engages with the first section to be engaged EG21 of the feed tray DS in the first state. In the example, the second engaging section EG12 is the upstream end of the first engaging section EG11 and engages with the second section to be engaged EG22 of the feed tray DS in the second state. In the example, the positioning section EG1 includes, together with the first engaging section EG11 and the second engaging section EG12, a third engaging section EG13 that engages with the first section to be engaged EG21 when the second engaging section EG12 and the second engaging section EG22 are engaged. The third engaging section EG13 is located below the second engaging section EG12 and further downstream in the conveyance direction than the second engaging section EG12. More specifically, the third engaging section EG13 is a recess formed downward from the first engaging section EG11. For this reason, when the third engaging section EG13 and the first section to be engaged EG21 engage, the first section to be engaged EG21 is caught by the third engaging section EG13, whereby the feed tray DS does not slide in the conveyance direction with the gravity. That is, in this case, in the image reading apparatus 1, the position of the feed tray DS can be fixed even when the feed tray DS is inclined.

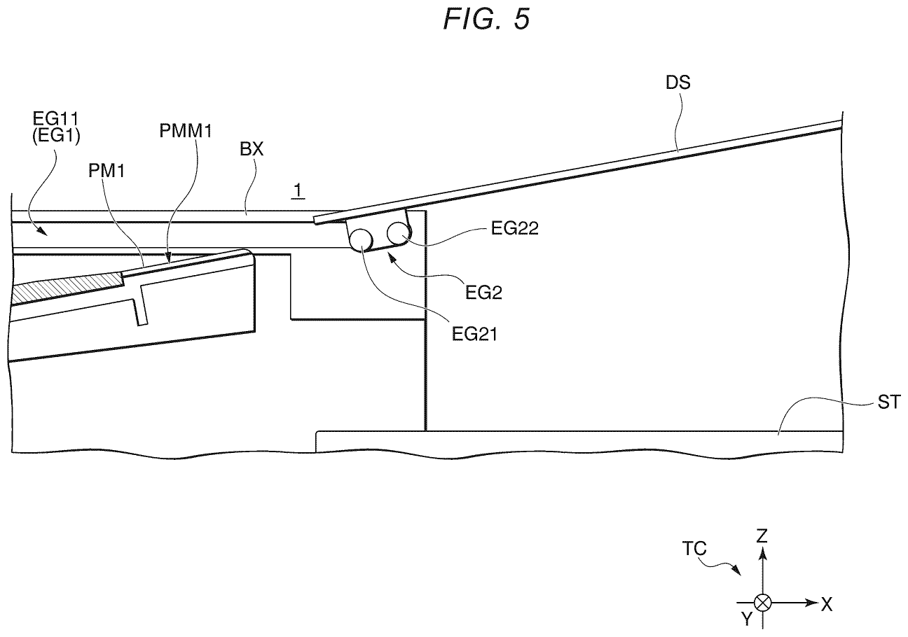

FIG. 5 is a side cross-sectional view illustrating the feed tray DS in the case in which the first section to be engaged EG21 and the third engaging section EG13 are engaged. In an example illustrated in FIG. 5, the first section to be engaged EG21 is engaged with the third engaging section EG13. In the example, the second section to be engaged EG22 is engaged with the second engaging section EG12. Accordingly, in the image reading apparatus 1, the upper surface of the feed tray DS can be inclined. For example, the user can engage the first section to be engaged EG21 with the third engaging section EG13 by bringing the state of the feed tray DS into the second state by sliding the feed tray DS in the pull-out direction and engaging the second section to be engaged EG22 with the second engaging section EG12 and thereafter lifting the upstream end of the feed tray DS. This allows the medium CP1 to slide to the downstream side in the conveyance direction with gravity and is useful.

Here, the feed tray DS includes a feed-side flat section DS11 having a flat surface on which the medium CP1 is placed and a feed-side protruding section DS12 protruding in the vertical direction from the upstream end of the feed-side flat section DS11 in the case in which the state of the feed tray DS is the first state. In the example illustrated in FIG. 3, the feed-side protruding section DS12 is a flat plate-shaped member and, in this case, constitutes a part of the front surface of the image reading apparatus 1. On the other hand, the discharge tray ST includes a discharge-side flat section ST11 having a plane on which the medium CP1 is placed and a discharge-side protruding section ST12 protruding in a direction opposite to the vertical direction from the upstream end of the discharge-side flat section ST11 in this case.

As illustrated in FIG. 3, at least a part of the feed-side protruding section DS12 overlaps the discharge-side protruding section ST12 in the pull-out direction. Specifically, the feed-side protruding section DS12 and the discharge-side protruding section ST12 are disposed side by side in the order of the discharge-side protruding section ST12 and the feed-side protruding section DS12 in the pulling-out direction. In the example illustrated in FIG. 3, when the state of the feed tray DS is the first state, the feed-side protruding section DS12 is in contact with the discharge-side protruding section ST12. Therefore, the discharge-side protruding section ST12 moves the feed tray DS in the pull-out direction by the discharge-side protruding section ST12 pressing the feed-side protruding section DS12 according to the movement of the discharge tray ST in the pull-out direction. Therefore, in the image reading apparatus 1 illustrated in FIG. 3, the user can pull out the feed tray DS together with the discharge tray ST by pulling out the discharge tray ST in the pull-out direction. As a result, the image reading apparatus 1 can reduce the time and time for the user to individually pull out the feed tray DS and the discharge tray ST and, as a result, can improve the convenience of the user. In the case, the feed-side protruding section DS12 may be separated from the discharge-side protruding section ST12. Even in this case, as long as at least a part of the feed-side protruding section DS12 overlaps the discharge-side protruding section ST12 in the pull-out direction, the discharge-side protruding section ST12 can move the feed tray DS in the pull-out direction according to the movement of the discharge tray ST in the pull-out direction. However, when the state of the feed tray DS is the first state and the feed-side protruding section DS12 is in contact with the discharge-side protruding section ST12, the user can always associate the movement of the discharge tray ST and the movement of the feed tray DS when pulling out the discharge tray ST in the pull-out direction. As a result, the image reading apparatus 1 can reduce an operation burden on the user. Further, the feed-side protruding section DS12 may protrude in the direction opposite to the vertical direction and the discharge-side protruding section ST12 may protrude in the vertical direction. Even in this case, as long as at least a part of the feed-side protruding section DS12 overlaps the discharge-side protruding section ST12 in the pull-out direction, the discharge-side protruding section ST12 can move the feed tray DS in the pull-out direction according to the movement of the discharge tray ST in the pull-out direction.

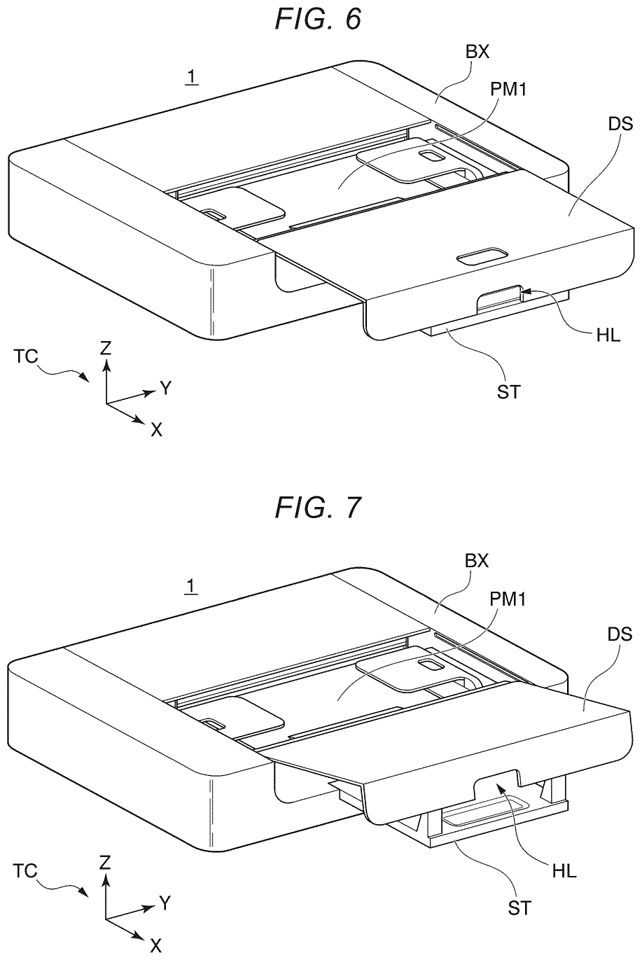

FIG. 6 is a perspective view illustrating an example of the feed tray DS pulled out in the pull-out direction together with the discharge tray ST by pulling out the discharge tray ST in the pull-out direction. As illustrated in FIG. 6, when the discharge tray ST is pulled out in the pull-out direction, the feed tray DS is also pushed by the discharge tray ST and pulled out in the pull-out direction. Accordingly, the image reading apparatus 1 can reduce labor and time for the user to individually pull out the feed tray DS and the discharge tray ST and, as a result, can improve the convenience of the user.

In the example illustrated in FIG. 6, a surface on the pull-out direction side among surfaces of the feed tray DS includes an opening HL. The opening HL does not overlap the discharge-side protruding section ST12 in the pull-out direction. For this reason, when the user pulls out the discharge-side protruding section ST12 in the pull-out direction, the user can hook a finger on the discharge tray ST through the opening HL. As a result, the image reading apparatus 1 can facilitate pull-out of the discharge tray ST by the user. When the user lifts the feed tray DS in the second state upward, the user can hook a finger on the feed tray DS through the opening HL. As a result, the image reading apparatus 1 can facilitate lifting of the feed tray DS by the user. FIG. 7 is a perspective view illustrating an example of a state in which the upstream end of the feed tray DS in the second state is lifted upward. In the feed tray DS illustrated in FIG. 7, the first section to be engaged EG21 is engaged with the third engaging section EG13 explained above. For this reason, in the example illustrated in FIG. 7, the feed tray DS is held in a state in which the upper surface is kept inclined.

In the example illustrated in FIG. 6, the feed-side protruding section DS12 also functions as an operation section with which the user operates the feed tray DS when pushing the feed tray DS in a pushing direction opposite to the pull-out direction. In this case, the user can push the discharge tray ST in the pushing direction together with the feed tray DS by pushing the feed-side protruding section DS12 in the pushing direction. As a result, the image reading apparatus 1 can reduce labor and time for the user to individually push in the feed tray DS and the discharge tray ST and, as a result, can more securely improve the convenience of the user. The operation section may be separate from the feed-side protruding section DS12.

As illustrated in FIG. 3, the image reading apparatus 1 further includes an urging member SP1 that urges the discharge tray ST in the pull-out direction and a restriction section LM1 that restricts the movement of the discharge tray ST.

The restriction section LM1 restricts the movement of the discharge tray ST in the pull-out direction when the state of the feed tray DS is the first state. The restriction section LM1 releases the restriction of the movement of the discharge tray ST by the restriction section LM1 in response to operation received from the user. The configuration of the restriction section LM1 may be any configuration if the restriction of the movement of the discharge tray ST in the case and the release of the restriction according to the operation can be performed in the configuration. For this reason, in FIG. 3, the restriction section LM1 is illustrated as a rectangular object.

The urging member SP1 may be any member if the member is capable of urging the discharge tray ST in the pull-out direction when the state of the feed tray DS is the first state. The urging member SP1 is, for example, a coil spring that urges the downstream end of the discharge tray ST in the pull-out direction. The urging member SP1 is provided in the housing BX and moves the discharge tray ST in the pull-out direction with respect to the housing BX when the restriction of the movement of the discharge tray ST by the restriction section LM1 is released. Accordingly, the image reading apparatus 1 can assist the user in pulling out the discharge tray ST in the pull-out direction. That is, the image reading apparatus 1 can reduce a force applied to the discharge tray ST by the user in order to pull out the feed tray DS in the pull-out direction together with the discharge tray ST.

The restriction section LM1 may be configured to restrict the movement of the feed tray DS in the pull-out direction when the state of the feed tray DS is the first state. In this case, the restriction section LM1 releases the restriction of the movement of the feed tray DS by the restriction section LM1 in response to operation received from the user. Accordingly, the image reading apparatus 1 can also assist the user in pulling out the discharge tray ST in the pull-out direction. This is because the restriction also restricts the movement of the discharge tray ST in the pull-out direction together with the movement of the feed tray DS in the pull-out direction. This is because the discharge-side protruding section ST12 and the feed-side protruding section DS12 overlap in the pull-out direction and the discharge-side protruding section ST12 and the feed-side protruding section DS12 are in contact when the state of the feed tray DS is the first state. The urging member SP1 may be configured to urge the feed tray DS in the pull-out direction when the state of the feed tray DS is the first state. Even in this case, the urging member SP1 is provided in the housing BX and moves the feed tray DS in the pull-out direction with respect to the housing BX when the restriction of the movement of the discharge tray ST or the feed tray DS by the restriction section LM1 is released. Accordingly, the image reading apparatus 1 can assist the user in pulling out the discharge tray ST in the pull-out direction. That is, the image reading apparatus 1 can reduce the force applied to the feed tray DS by the user in order to pull out the discharge tray ST in the pull-out direction together with the feed tray DS.

As explained above, in the image reading apparatus 1, the feed tray DS moves in the pull-out direction according to the movement of the discharge tray ST in the pull-out direction. Accordingly, the image reading apparatus 1 can reduce labor and time for the user to individually pull out the feed tray DS and the discharge tray ST and, as a result, can improve the convenience of the user.

### Modification 1 of the Embodiment

A modification 1 of the embodiment is explained below. In the image reading apparatus 1 according to the modification 1 of the embodiment, the discharge tray ST moves in the pull-out direction according to the movement of the feed tray DS in the pull-out direction. That is, in the modification 1 of the embodiment, the operation tray is the feed tray DS. In the modification 1 of the embodiment, the driven tray is the discharge tray ST.

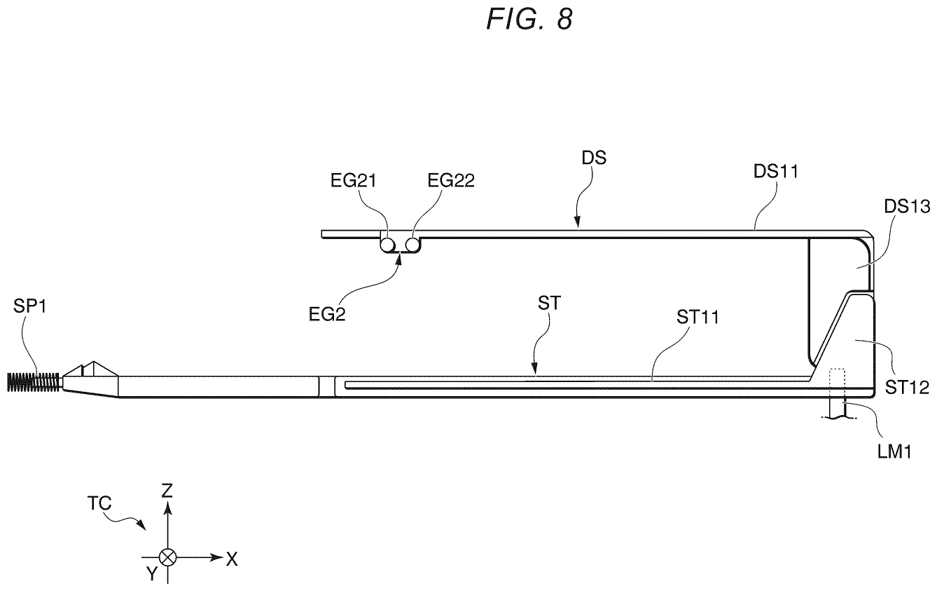

FIG. 8 is a side view illustrating another example of the configuration of the feed tray DS and the discharge tray ST. In the example illustrated in FIG. 8, the feed tray DS includes a feed-side protruding section DS13 instead of the feed-side protruding section DS12.

As illustrated in FIG. 8, at least a part of the feed-side protruding section DS13 overlaps the discharge-side protruding section ST12 in the pull-out direction. Specifically, the feed-side protruding section DS13 and the discharge-side protruding section ST12 are disposed side by side in the order of the feed-side protruding section DS13 and the discharge-side protruding section ST12 in the pull-out direction. Further, in the example illustrated in FIG. 8, when the state of the feed tray DS is the first state, the feed-side protruding section DS13 is in contact with the discharge-side protruding section ST12. Therefore, the feed-side protruding section DS13 moves the discharge tray ST in the pull-out direction by pushing the discharge-side protruding section ST12 according to the movement of the feed tray DS in the pull-out direction. Therefore, in the image reading apparatus 1 illustrated in FIG. 8, the user can pull out the discharge tray ST together with the feed tray DS by pulling out the feed tray DS in the pull-out direction. As a result, the image reading apparatus 1 can reduce the time and time for the user to individually pull out the feed tray DS and the discharge tray ST and, as a result, can improve the convenience of the user. In the case, the discharge-side protruding section ST12 may be separated from the feed-side protruding section DS13. Even in this case, as long as at least a part of the feed-side protruding section DS13 overlaps the discharge-side protruding section ST12 in the pull-out direction, the feed-side protruding section DS13 can move the discharge tray ST in the pull-out direction according to the movement of the feed tray DS in the pull-out direction. However, when the state of the feed tray DS is the first state and the feed-side protruding section DS13 is in contact with the discharge-side protruding section ST12, the user can always associate the movement of the discharge tray ST and the movement of the feed tray DS when pulling out the feed tray DS in the pull-out direction. As a result, the image reading apparatus 1 can reduce an operation burden on the user. Further, the feed-side protruding section DS13 may protrude in the direction opposite to the vertical direction and the discharge-side protruding section ST12 may protrude in the vertical direction. Even in this case, as long as at least a part of the feed-side protruding section DS13 overlaps the discharge-side protruding section ST12 in the pull-out direction, the discharge-side protruding section ST12 can move the feed tray DS in the pull-out direction according to the movement of the discharge tray ST in the pull-out direction.

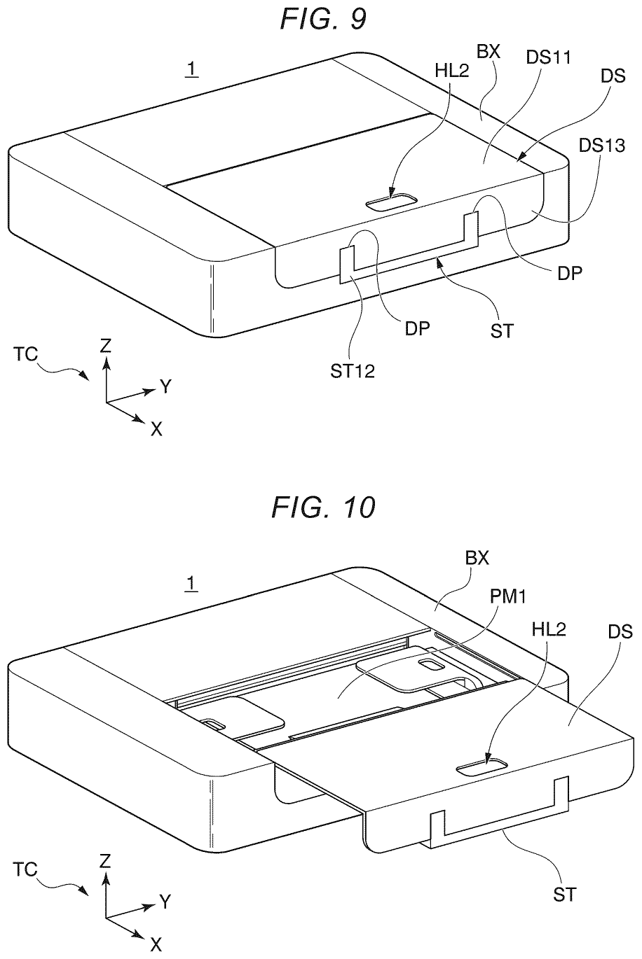

FIG. 9 is a perspective view illustrating an example of a state in which the state of the feed tray DS is the first state in the image reading apparatus 1 according to the modification 1 of the embodiment. As illustrated in FIG. 9, the feed-side protruding section DS13 includes a recess DP. The discharge-side protruding section ST12 is fitted in the recess DP according to the movement in the pushing direction. The state of the discharge-side protruding section ST12 illustrated in FIG. 9 is a state of being fit in the recess DP. In the example illustrated in FIG. 9, a surface on the pull-out direction side among surfaces of the discharge-side protruding section ST12 fit in the recess DP is included in a virtual surface including a surface on the pull-out direction side among surfaces of the feed-side protruding section DS12. In other words, in the example, the surface on the pull-out direction side among the surfaces of the discharge-side protruding section ST12 fit in the recess DP is flush with the surface on the pull-out direction side among the surfaces of the feed-side protruding section DS12. Accordingly, the image reading apparatus 1 can prevent unnecessary unevenness from appearing on the exterior of the image reading apparatus 1 when the state of the feed tray DS is the first state and, as a result, can prevent the image reading apparatus 1 from being caught by another object such as a finger of the user. This also leads to a reduction in the size of the image reading apparatus 1 and is useful.

In the example illustrated in FIG. 9, a grip section HL2 that can be gripped in order to move the feed tray DS in the pull-out direction is provided on the upper surface of the feed tray DS, that is, the upper surface of the feed-side flat section DS11. Accordingly, the image reading apparatus 1 can facilitate the pull-out of the feed tray DS in the pull-out direction by the user. The grip section HL2 may have any configuration as long as the grip section HL2 can be gripped in order to move the feed tray DS in the pull-out direction. In this example, the grip section HL2 is an opening provided in the upper surface of the feed tray DS, that is, the upper surface of the feed-side flat section DS11. In this case, the image reading apparatus 1 can allow the user to pull out the feed tray DS in the pull-out direction by hooking a finger on the feed tray DS and, as a result, can improve usability of the image reading apparatus 1. When the grip section HL2 is the opening as explained above, in the image reading apparatus 1, the grip section HL2 does not need to be protruded toward the outer side of the housing BX. Therefore, it is possible to prevent the image reading apparatus 1 from increasing in size because the image reading apparatus 1 includes the grip section HL2. Note that the grip section HL2 may be provided in another part of the feed tray DS instead of the upper surface of the feed tray DS.

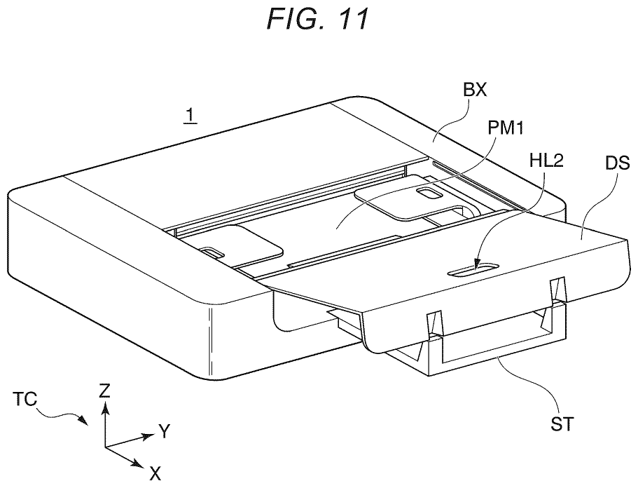

FIG. 10 is a diagram illustrating an example of the discharge tray ST pulled out in the pull-out direction together with the feed tray DS by pulling out the feed tray DS in the pull-out direction. As illustrated in FIG. 10, when the feed tray DS is pulled out in the pull-out direction, the discharge tray ST is also pushed by the feed tray DS and pulled out in the pull-out direction. Accordingly, the image reading apparatus 1 can reduce labor and time for the user to individually pull out the feed tray DS and the discharge tray ST and, as a result, can improve the convenience of the user.

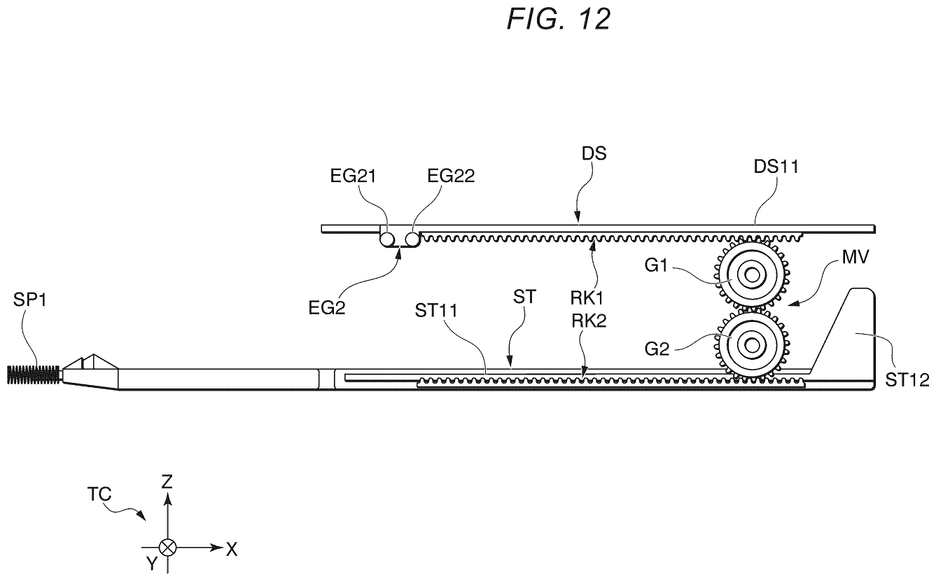

When the user lifts the feed tray DS in the second state upward, the user can hook a finger on the feed tray DS through the grip section HL2. As a result, the image reading apparatus 1 can facilitate lifting of the feed tray DS by the user. FIG. 11 is a perspective view illustrating another example of the state in which the upstream end of the feed tray DS in the second state is lifted upward. In the feed tray DS illustrated in FIG. 11, the first section to be engaged EG21 is engaged with the third engaging section EG13 explained above. For this reason, in the example illustrated in FIG. 11, the feed tray DS is held in a state in which the upper surface is inclined.

In the example illustrated in FIG. 10, the discharge-side protruding section ST12 also functions as an operation section with which the user operates the discharge tray ST when pushing in the discharge tray ST in the pushing direction. In this case, the user can push the feed tray DS in the pushing direction together with the discharge tray ST by pushing the discharge-side protruding section ST12 in the pushing direction. As a result, the image reading apparatus 1 can reduce labor and time for the user to individually push in the feed tray DS and the discharge tray ST and, as a result, can more securely improve the convenience of the user. The operation section may be separate from the discharge-side protruding section ST12.

In the modification 1 of the embodiment as well, as illustrated in FIG. 8, the image reading apparatus 1 further includes the urging member SP1 that urges the discharge tray ST in the pull-out direction and the restriction section LM1 that restricts the movement of the discharge tray ST. Accordingly, the image reading apparatus 1 can assist the user in pulling out the feed tray DS in the pull-out direction. That is, the image reading apparatus 1 can reduce the force applied to the feed tray DS by the user in order to pull out the discharge tray ST in the pull-out direction together with the feed tray DS.

The restriction section LM1 may be configured to restrict the movement of the feed tray DS in the pull-out direction when the state of the feed tray DS is the first state. In this case, the restriction section LM1 releases the restriction of the movement of the feed tray DS by the restriction section LM1 in response to operation received from the user. Accordingly, the image reading apparatus 1 can also assist the user in pulling out the feed tray DS in the pull-out direction. This is because the restriction also restricts the movement of the discharge tray ST in the pull-out direction together with the movement of the feed tray DS in the pull-out direction. This is because the discharge-side protruding section ST12 and the feed-side protruding section DS13 overlap in the pull-out direction and the discharge-side protruding section ST12 and the feed-side protruding section DS13 are in contact when the state of the feed tray DS is the first state.

The urging member SP1 may be configured to urge the feed tray DS in the pull-out direction when the state of the feed tray DS is the first state. Even in this case, the urging member SP1 is provided in the housing BX and moves the feed tray DS in the pull-out direction with respect to the housing BX when the restriction of the movement of the discharge tray ST or the feed tray DS by the restriction section LM1 is released. Accordingly, the image reading apparatus 1 can assist the user in pulling out the feed tray DS in the pull-out direction. That is, the image reading apparatus 1 can reduce the force applied to the feed tray DS by the user in order to pull out the discharge tray ST in the pull-out direction together with the feed tray DS.

As explained above, in the image reading apparatus 1 according to the modification 1 of the embodiment, the discharge tray ST moves in the pull-out direction according to the movement of the feed tray DS in the pull-out direction. Accordingly, the image reading apparatus 1 can reduce labor and time for the user to individually pull out the feed tray DS and the discharge tray ST and, as a result, can improve the convenience of the user.

### Modification 2 of the Embodiment

A modification 2 of the embodiment is explained below. The modification 2 of the embodiment is a combination of the embodiment and the modification 1 of the embodiment. Specifically, in the modification 2 of the embodiment, the image reading apparatus 1 includes a part where the feed tray DS and the discharge tray ST overlap in the order of the feed tray DS and the discharge tray ST in the pull-out direction and a part where the discharge tray ST and the feed tray DS overlap in the order of the discharge tray ST and the feed tray DS in the pull-out direction. Accordingly, in the image reading apparatus 1, the discharge tray ST can be pulled out in the pull-out direction together with the feed tray DS by pulling out the feed tray DS in the pull-out direction and the feed tray DS can be pulled out in the pull-out direction together with the discharge tray ST by pulling out the discharge tray ST in the pull-out direction. As a result, the image reading apparatus 1 can more securely improve the convenience of the user.

### Modification 3 of the Embodiment

A modification 3 of the embodiment is explained below. The modification 3 of the embodiment includes a moving mechanism MV that moves the driven tray in the pull-out direction according to the movement of the operation tray in the pull-out direction. Accordingly, in the image reading apparatus 1, both of the feed tray DS and the discharge tray ST are moved in the pull-out direction regardless of which of the feed tray DS and the discharge tray ST is treated as the operation tray. Therefore, the image reading apparatus 1 can reduce labor and time for the user to individually pull out the feed tray and the discharge tray and, as a result, can improve convenience of the user.

FIG. 12 is a side view illustrating still another example of the configuration of the feed tray DS and the discharge tray ST. In the example illustrated in FIG. 12, the feed tray DS includes a first meshing section RK1 extending in the pull-out direction when the state of the feed tray DS is the first state. In the example, the discharge tray ST includes a second meshing section RK2 extending in the pull-out direction in the case. In the example, the second meshing section RK2 is located at a position facing the first meshing section RK1.

Here, the moving mechanism MV is a mechanism that meshes with each of the first meshing section RK1 and the second meshing section RK2 and moves the driven tray in the pull-out direction according to the movement of the operation tray in the pull-out direction. The moving mechanism MV may be any mechanism as long as it is capable of meshing with each of the first meshing section RK1 and the second meshing section RK2 and moving the driven tray in the pull-out direction according to the movement of the operation tray in the pull-out direction. In the example illustrated in FIG. 12, the moving mechanism MV includes a gear train of two gears, that is, a first gear G1 and a second gear G2 meshing with the first gear G1. The first gear G1 is in mesh with the first meshing section RK1. The second gear G2 is in mesh with the second meshing section RK2. For this reason, when the user pulls out the operation tray in the pull-out direction, the driven tray is also pulled out in the pull-out direction by driving of the gear train. Accordingly, the image reading apparatus 1 can more securely reduce the operation burden on the user. When the image reading apparatus 1 includes the moving mechanism MV, amounts of movement of the operation tray and the driven tray can be adjusted by changing the specifications of the first meshing section RK1, the second meshing section RK2, the first gear G1, and the second gear G2. As a result, in the image reading apparatus 1, for example, the size of each of the feed tray DS and the discharge tray ST can be changed according to a use and a protrusion amount of each of the feed tray DS and the discharge tray ST from the housing BX can be adjusted. This improves a degree of freedom of design of the image reading apparatus 1 and is useful.

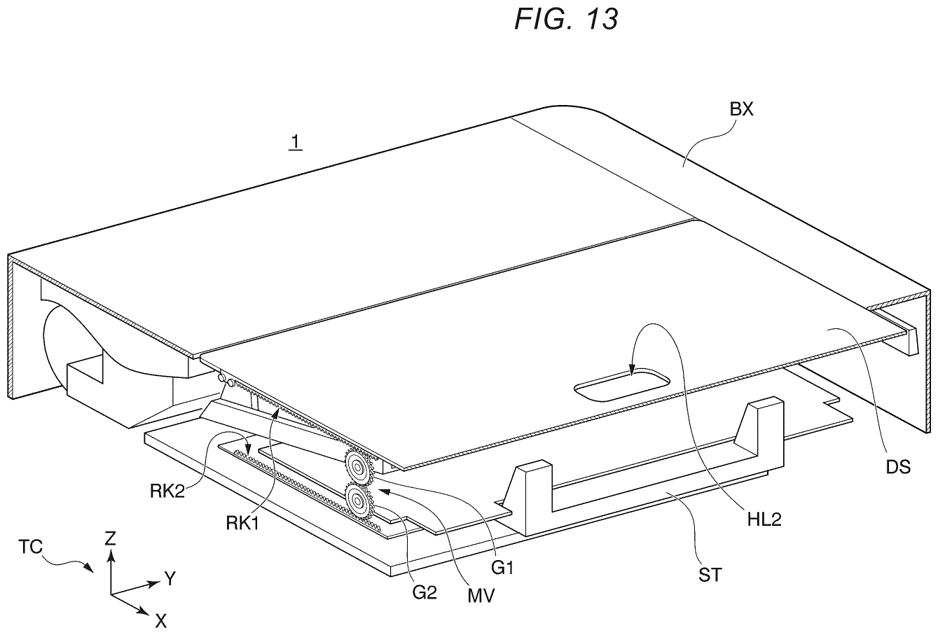

In the moving mechanism MV explained above, at least one of at least a part of the first gear G1 and at least a part of the second gear G2 is housed in the housing BX as illustrated in FIG. 13. FIG. 13 is a perspective view illustrating an example of a state in which the first gear G1 and the second gear G2 of the moving mechanism MV are housed in the housing BX. However, in FIG. 13, in order to clearly illustrate the first gear G1 and the second gear G2 housed in the housing BX, a part of the housing BX and a part of the feed tray DS are omitted.

In the example illustrated in FIG. 13, the entire first gear G1 and the entire second gear G2 are housed in the housing BX. In this case, in the image reading apparatus 1, another object such as the medium CP1 and each of the first gear G1 and the second gear G2 can be prevented from interfering with each other. In the image reading apparatus 1, a part or the entire first gear G1 may not be housed in the housing BX. In the image reading apparatus 1, a part or the entire second gear G2 may not be housed in the housing BX.

The matters explained above may be combined in any way. For example, the feed tray DS according to the modification 2 of the embodiment may include the section to be positioned EG2 explained above. In this case, the housing BX according to the modification 2 of the embodiment includes the positioning section EG1. Accordingly, in the image reading apparatus 1 according to the modification 2 of the embodiment, when the position of the feed tray DS in the second state is fixed by inclining the feed tray DS, it is possible to prevent the user from erroneously pushing each of the feed tray DS and the discharge tray ST in the pushing direction at the time of printing.

### APPENDICES

[1] An image reading apparatus that reads an image from a target medium from which the image is read, the image reading apparatus including: a feed tray on which the medium is placed; a conveyance unit configured to convey, from the feed tray, the medium placed on the feed tray; an image reading unit configured to read an image from the medium conveyed by the conveyance unit; a discharge tray to which the medium from which the image was read by the image reading unit is discharged; and a housing configured to house the conveyance unit and the image reading unit on an inside, wherein the feed tray and the discharge tray are capable of being pulled out in a pull-out direction, and, according to movement of one of the feed tray and the discharge tray in the pull-out direction, the other of the feed tray and the discharge tray moves in the pull-out direction.

[2] The image reading apparatus described in [1], wherein the discharge tray includes a first protruding section protruding from the discharge tray in a direction opposite to a vertical direction, the feed tray includes a second protruding section protruding from the feed tray in the vertical direction, at least a part of the second protruding section overlaps the first protruding section in the pull-out direction, and a protruding section provided in the one tray of the first protruding section and the second protruding section moves the other tray in the pull-out direction by pushing a protruding section provided in the other tray of the first protruding section and the second protruding section in the pull-out direction according to movement of the one tray in the pull-out direction.

[3] The image reading apparatus described in [2], wherein the feed tray is located above the discharge tray in the vertical direction, and the first protruding section and the second protruding section are disposed side by side in order of the second protruding section and the first protruding section in the pull-out direction.

[4] The image reading apparatus described in [3], wherein the second protruding section includes a recess, and the first protruding section is fitted in the recess of the second protruding section according to movement in a direction opposite to the pull-out direction.

[5] The image reading apparatus described in [3] or [4], wherein the feed tray includes a grip section capable of being gripped in order to move the feed tray in the pull-out direction.

[6] The image reading apparatus described in [5], wherein the grip section is an opening provided in an upper surface of the feed tray.

[7] The image reading apparatus described in any one of [3] to [6], wherein the discharge tray includes an operation section, and the feed tray moves in a direction opposite to the pull-out direction in response to operation on the operation section of the discharge tray in the opposite direction.

[8] The image reading apparatus described in [2], wherein the feed tray is located above the discharge tray in the vertical direction, and the first protruding section and the second protruding section are disposed side by side in order of the first protruding section and the second protruding section in the pull-out direction.

[9] The image reading apparatus described in [8], wherein the feed tray is located above the discharge tray in the vertical direction, a surface on the pull-out direction side among surfaces of the second protruding section includes an opening, and the opening provided in the second protruding section does not overlap the first protruding section in the pull-out direction.

[10] The image reading apparatus described in [9], wherein the feed tray includes an operation section, the one tray is the discharge tray, and the discharge tray moves in a direction opposite to the pull-out direction in response to operation on the operation section of the feed tray in the opposite direction.

[11] The image reading apparatus described in any one of [8] to [10], further including: a first urging member configured to urge the feed tray in the pull-out direction; and a first restriction section configured to restrict movement of the feed tray, wherein the one tray is the feed tray, and the first urging member moves the feed tray in the pull-out direction with respect to the housing when the restriction of the movement of the feed tray by the first restriction section is released.

[12] The image reading apparatus described in any one of [8] to [10], further including: a first urging member configured to urge the feed tray in the pull-out direction; and a second restriction section configured to restrict movement of the discharge tray, wherein the one tray is the feed tray, and the first urging member moves the feed tray in the pull-out direction with respect to the housing when the restriction of the movement of the discharge tray by the second restriction section is released.

[13] The image reading apparatus described in any one of [3] to [7], further including: a second urging member configured to urge the discharge tray in the pull-out direction; and a second restriction section configured to restrict movement of the discharge tray, wherein the one tray is the discharge tray, and the second urging member moves the discharge tray in the pull-out direction with respect to the housing when the restriction of the movement of the discharge tray by the second restriction section is released.

[14] The image reading apparatus described in any one of [3] to [7], further including: a second urging member configured to urge the discharge tray in the pull-out direction; and a first restriction section configured to restrict movement of the feed tray, wherein the one tray is the discharge tray, and the second urging member moves the discharge tray in the pull-out direction with respect to the housing when the restriction of the movement of the feed tray by the first restriction section is released.

[15] The image reading apparatus described in any one of [1] to [14], wherein the feed tray includes a first meshing section extending in the pull-out direction, the discharge tray includes a second meshing section at a position facing the first meshing section, the second meshing section extends in the pull-out direction, and the image reading apparatus further includes a moving mechanism configured to mesh with each of the first meshing section and the second meshing section and move the other tray in the pull-out direction according to movement of the one tray in the pull-out direction.

[16] The image reading apparatus described in [15], wherein the moving mechanism includes: a first gear; and a second gear that meshes with the first gear, the first gear is in mesh with the first meshing section, and the second gear is in mesh with the second meshing section.

[17] The image reading apparatus described in [16], wherein at least one of at least a part of the first gear and at least a part of the second gear is housed in the housing.

[18] The image reading apparatus described in any one of [1] to [17], wherein the housing includes a positioning section that determines a position of the feed tray, and the feed tray includes a section to be positioned that is positioned by the positioning section.

[19] A printing apparatus including: a print head configured to print an image on a medium; and the image reading apparatus described in any one of [1] to [18].

The embodiment of the present disclosure is explained in detail above with reference to the drawings. However, a specific configuration is not limited to the embodiment and may be, for example, changed, replaced, or deleted without departing from the gist of the present disclosure.

What is claimed is:

1. An image reading apparatus that is attached to a printing apparatus and reads an image from a target medium from which the image is read, the image reading apparatus comprising:
a feed tray on which the medium is placed;
a conveyance unit configured to convey, from the feed tray, the medium placed on the feed tray;
an image reading unit configured to read an image from the medium conveyed by the conveyance unit;
a discharge tray to which the medium from which the image was read by the image reading unit is discharged; and
a housing configured to house the conveyance unit and the image reading unit on an inside, wherein
the feed tray and the discharge tray are capable of being pulled out in a pull-out direction that is a direction from a rear surface to a front surface of the housing and intersects a vertical direction, and
according to movement of one of the feed tray and the discharge tray in the pull-out direction, the other of the feed tray and the discharge tray moves in the pull-out direction.

2. The image reading apparatus according to claim 1, wherein
the discharge tray includes a first protruding section protruding from the discharge tray in a direction opposite to the vertical direction,
the feed tray includes a second: protruding section protruding from the feed tray in the vertical direction,
at least a part of the second protruding section overlaps the first protruding section in the pull-out direction, and
a protruding section provided in the one tray having either the first protruding section or the second protruding section moves the other tray in the pull-out direction by pushing a protruding section provided in the other tray having either the first protruding section or the second protruding section in the pull-out direction according to movement of the one tray in the pull-out direction.

3. The image reading apparatus according to claim 2, wherein the first protruding section and the second protruding section are disposed side by side in order of the second protruding section and the first protruding section in the pull-out direction.

4. The image reading apparatus according to claim 3, wherein
the second protruding section includes a recess, and
the first protruding section is fitted in the recess of the second protruding section according to movement in a direction opposite to the pull-out direction.

5. The image reading apparatus according to claim 3, wherein the feed tray includes a grip section capable of being gripped in order to move the feed tray in the pull-out direction.

6. The image reading apparatus according to claim 5, wherein the grip section is located on an upper surface of the feed tray.

7. The image reading apparatus according to claim 3, wherein
the discharge tray includes an operation section, and
the feed tray moves in a direction opposite to the pull-out direction in response to operation on the operation section of the discharge tray in the opposite direction.

8. The image reading apparatus according to claim 2, wherein the first protruding section and the second protruding section are disposed side by side in order of the first protruding section and the second protruding section in the pull-out direction.

9. The image reading apparatus according to claim 8, wherein
the feed tray is located above the discharge tray in the vertical direction,
a surface on the pull-out direction side among surfaces of the second protruding section includes an opening, and
the opening provided in the second protruding section does not overlap the first protruding section in the pull-out direction.

10. The image reading apparatus according to claim 9, wherein
the feed tray includes an operation section,
the one tray is the discharge tray, and
the discharge tray moves in a direction opposite to the pull-out direction in response to operation on the operation section of the feed tray in the opposite direction.

11. The image reading apparatus according to claim 8, further comprising:
a first urging member configured to urge the feed tray in the pull-out direction; and
a first restriction section configured to restrict movement of the feed tray, wherein
the one tray is the feed tray, and
the first urging member moves the feed tray in the pull-out direction with respect to the housing when the restriction of the movement of the feed tray by the first restriction section is released.

12. The image reading apparatus according to claim 8, further comprising:
a first urging member configured to urge the feed tray in the pull-out direction; and
a second restriction section configured to restrict movement of the discharge tray, wherein
the one tray is the feed tray, and
the first urging member moves the feed tray in the pull-out direction with respect to the housing when the restriction of the movement of the discharge tray by the second restriction section is released.

13. The image reading apparatus according to claim 3, further comprising:
a second urging member configured to urge the discharge tray in the pull-out direction; and
a second restriction section configured to restrict movement of the discharge tray, wherein
the one tray is the discharge tray, and
the second urging member moves the discharge tray in the pull-out direction with respect to the housing when the restriction of the movement of the discharge tray by the second restriction section is released.

14. The image reading apparatus according to claim 3, further comprising:
a second urging member configured to urge the discharge tray in the pull-out direction; and
a first restriction section configured to restrict movement of the feed tray, wherein
the one tray is the discharge tray, and
the second urging member moves the discharge tray in the pull-out direction with respect to the housing when the restriction of the movement of the feed tray by the first restriction section is released.

15. The image reading apparatus according to claim 1, wherein
the feed tray includes a first meshing section extending in the pull-out direction,
the discharge tray includes a second meshing section at a position facing the first meshing section,
the second meshing section extends in the pull-out direction, and
the image reading apparatus further comprises a moving mechanism configured to mesh with each of the first meshing section and the second meshing section and move the other tray in the pull-out direction according to movement of the one tray in the pull-out direction.

16. The image reading apparatus according to claim 15, wherein the moving mechanism includes:
a first gear; and
a second gear configured to mesh with the first gear,
the first gear is in mesh with the first meshing section, and
the second gear is in mesh with the second meshing section.

17. The image reading apparatus according to claim 16, wherein at least one of at least a part of the first gear and at least a part of the second gear is housed in the housing.

18. The image reading apparatus according to claim 1, wherein the pull-out direction intersects a front surface of the housing and extends in a direction from a rear surface to the front surface of the housing.

19. A printing apparatus comprising:
a print head configured to print an image on a medium; and
the image reading apparatus according to claim 1.

20. A medium conveyance apparatus comprising:
a feed tray on which a medium is placed;
a conveyance unit configured to convey, from the feed tray, the medium placed on the feed tray;
a discharge tray to which the medium conveyed by the conveyance unit is discharged; and
a housing configured to house the conveyance unit on an inside, wherein
the feed tray and the discharge tray are capable of being pulled out in a pull-out direction that is a direction from a rear surface to a front surface of the housing, and
according to movement of one of the feed tray and the discharge tray in the pull-out direction, the other of the feed tray and the discharge tray moves in the pull-out direction.
